(19) United States
(12) Patent Application Publication
(10) Pub. No.: US 2022/0140354 A1
(43) Pub. Date: May 5, 2022

(54) FUEL CELL ELECTRODE WITH CATALYSTS GROWN IN SITU ON ORDERED STRUCTURE MICROPOROUS LAYER AND METHOD FOR PREPARING MEMBRANE ELECTRODE ASSEMBLY

(71) Applicant: Jiangsu University, Jiangsu (CN)

(72) Inventors: Huaneng SU, Jiangsu (CN); Jinlong LI, Jiangsu (CN); Weiqi ZHANG, Jiangsu (CN); Qiang MA, Jiangsu (CN); Qian XU, Jiangsu (CN)

(73) Assignee: Jiangsu University, Jiangsu (CN)

(21) Appl. No.: 17/446,187

(22) Filed: Aug. 27, 2021

(30) Foreign Application Priority Data
Oct. 30, 2020 (CN) 202011190962.X

(51) Int. Cl. H01M 4/86; H01M 8/04119; H01M 4/88; H01M 4/92; H01M 4/96

(52) U.S. Cl. CPC H01M 4/8636; H01M 8/04171; H01M 4/96; H01M 4/921; H01M 4/8828

(57) ABSTRACT

A fuel cell electrode with catalysts grown in situ on an ordered structure microporous layer and a method for preparing a membrane electrode assembly (MEA) are disclosed. The fuel cell electrode includes an electrode substrate layer, a hydrophobic layer, an ordered structure hydrophilic layer and catalysts. The hydrophobic layer is prepared on the electrode substrate layer. The ordered structure hydrophilic layer is prepared on the hydrophobic layer. The catalysts are uniformly distributed on the ordered structure hydrophilic layer.

### CROSS REFERENCE TO RELATED APPLICATION

This patent application claims the benefit and priority of Chinese Patent Application No. 202011190962.X filed on Oct. 30, 2020, the disclosure of which is incorporated by reference herein in its entirety as part of the present application.

### TECHNICAL FIELD

The present disclosure relates to the field of fuel cells, and in particular to a fuel cell electrode with catalysts grown in situ on an ordered structure microporous layer and a method for preparing the membrane electrode assembly (MEA).

### BACKGROUND ART

A proton exchange membrane fuel cell (PEMFC) is an efficient hydrogen energy conversion device, which can directly convert the chemical energy stored in hydrogen fuel and an oxidant into electric energy by means of electrochemical reaction. Such a fuel cell has many advantageous characteristics such as being environment-friendly, high specific energy, quick start-up at low temperature and highly stable operation, and it can be applied to many fields such as new energy vehicles, field mobile power supply and silent power supply. It is considered as an ideal power source to replace the internal combustion engine, and has received extensive attention and studies in recent years.

However, the research and development of PEMFC technology still faces problems such as high cost and short service life. There are two main ways to improve performance and reduce cost. One is to reduce the usage amount of the noble metal catalyst by changing its support, preparing alloy catalyst and the like, from the perspective of intrinsic activity of the catalyst, so as to improve the activity and the stability of the catalyst. However, because the electrochemical reaction process is also affected by many factors, such as three-phase interface and mass transfer channels of electrons, protons, gases and water, it is difficult to improve the cell performance comprehensively. The other approach is, from the perspective of the structure of a membrane electrode assembly (MEA) and the catalytic layer, the cell performance is improved by developing a new MEA preparation process and a new MEA preparation method, where by optimizing a wide range of factors that are involved, the reaction progress as a whole can be coordinated, and the cell performance is improved accordingly.

The MEA, as a core component of a PEMFC, provides a channel of multiphase material transfer and a site of electrochemical reaction. The performance of PEMFC is directly determined depending on the performance of MEA. The technical target of MEA for vehicles proposed by the Department of Energy (DOE) in 2020 are: cost less than $14 kW⁻¹, durability requirement up to 5000 h, and power density up to 1 W cm⁻² at rated power. Following those requirements, the total amount of noble metal Pt should be less than 0.125 mg cm⁻², and the current density should reach 0.44 A cm⁻² at 0.9 V.

The MEA mainly includes a gas diffusion layer (GDL), a catalytic layer (CL) and a proton exchange membrane (PEM). Various functional layers of MEA need to participate in the electrochemical reaction process and cooperate with each other. Specifically, the capabilities of the functional layer such as the mass transfer, catalysis and conduction restrict the performance of a PEMFC, and optimizing the structure of each functional layer thus plays an important role in improving the performance of a PEMFC.

The GDL is an important component in the MEA of a PEMFC. Typically, the GDL is a two-layer structure including a substrate and a microporous layer. The GDL acts as a transport channel to transport reactants from the flow channel to the CL and to discharge products. In addition, the GDL is also a transmission channel for electrons. The ideal GDL should have less mass transfer resistance, good water removal ability and lower resistance. However, in the traditional GDL, a layer of mixed slurry of conductive carbon powder and hydrophobic substance is generally coated on the surface of carbon paper (or carbon cloth). Further, such a disordered microporous layer structure results in serious resistance for mass transfer efficiency due to the risk of water flooding, which impairs the performance of the fuel cell. In recent years, a large number of researchers have carried out numerous structural optimizations for the disordered microporous layers. In Chinese Patent Application No. 201910972513.1, Rui Lin et al., a method for preparing a microporous layer of a fuel cell with drainage channels is disclosed. The difference between this method and the traditional microporous layer preparation is that a pore-forming agent is added into the microporous layer slurry, so that the obtained microporous layer has drainage channels with a certain size, which can realize a rapid water removal, does not affect the physical properties of materials around the hydrophobic pores, and the cost can be reduced. The microporous layer includes: multiple drainage channels and multiple non-drainage channels. The pore diameter of the drainage channels is 1-50 μm, and hydrophobic materials are distributed across the surface of the pore walls of the drainage channels; the pore diameter of the non-drainage channels is 0.05-0.5 μm. The results show that the pore diameter of the drainage channel is about 25 μm and the power density can reach 0.93W cm⁻² when the amount of pore-forming agent is 25% of the slurry in the microporous layer. In Chinese Patent Application No. 201911263629.4, a method for preparing a double-layer microporous layer type GDL is proposed, which prepares two kinds of microporous layer slurries. The first slurry includes carbon powder, absolute ethyl alcohol, a hydrophobic agent and a pore-forming agent; and the second slurry includes carbon powder, absolute ethyl alcohol and a hydrophobic agent. The first slurry is uniformly sprayed onto the surface of the GDL to form a first microporous layer, the second slurry is uniformly sprayed onto the first microporous layer to form a second microporous layer, and the double-layer microporous layer type GDL is then formed after acid treatment, drying and sintering.

The CL is a major site for electrochemical reactions in fuel cells, which requires not only good catalytic performance, but also good mass transport channels. Dalian Institute of Chemical Physics, Chinese Academy of Sciences (Chinese Patent Application No. 201611022937.4) made an invention involving a method for directly preparing a platinum monoatomic layer catalytic layer for a PEMFC. In the catalytic layer, a Pd/C catalytic layer is directly prepared by an electrospinning technology, then monatomic Cu is deposited on the Pd/C catalytic layer by an under-potential deposition method in a three-electrode system, then Pt of the monatomic layer is obtained by replacement, and finally a Pd/C@Pt_{ML} catalytic layer is prepared. The Pd/C@Pt_{ML} catalyst layer is configured as the cathode, and the maximum power density of the single cell is 560 mWcm⁻² (H₂-Air) with the loading of Pd 0.15 mg cm⁻² and Pt 0.02 mg cm⁻², which is superior to catalyst layer including the commercial cathode with the loading of Pt 0.09 mg cm⁻². The two catalytic layers were subjected to a single cell accelerated decay test, and it was found that the Pd/C@Pt_{ML} catalytic layer has better stability. Fa Zheng et al. (Chinese Patent Application No.201911051563.2) made an invention relating to a PEMFC catalytic layer and a preparation method thereof. The catalytic layer is a three-layer structure. The first layer of the catalytic layer is a mixed layer of Pt/C catalyst and polyvinylidene fluoride hexafluoropropylene copolymer adhesive, the second layer of the catalytic layer is a mixed layer of Pt/CNTs catalytic layer and Nafion adhesive, and the third layer of the catalytic layer is a mixed layer of Pt/C catalyst and PBI ionomer adhesive.

Although the pore-forming agent is added in the preparation of the microporous layer, the resulting micropores are not uniformly arranged, and the mass transfer channels of the microporous layer prepared by the spraying method are also in a disordered state. Most of the Pt catalysts in the catalytic layer are deposited on the surface of the support as spherical particles, and many active sites are hidden below the surface and therefore cannot play a catalytic role. Moreover, during long-term operation, the Pt catalysts may agglomerate or fall off, which greatly affects the performance and durability of the fuel cell. In addition, two contact interfaces exist among the support layer (carbon paper or carbon cloth), the microporous layer and the catalytic layer, which leads to increased mass transfer resistance of the MEA.

### SUMMARY

In contrast with the above approaches, the present disclosure provides an electrode with catalysts grown in situ on an ordered structure microporous layer. The electrode includes an electrode substrate layer, a hydrophobic layer, an ordered structure hydrophilic layer and catalysts. The microporous layer includes the hydrophobic layer and the ordered structure hydrophilic layer, and is presented in a vertical array rod-shaped structure having good mass transfer channel and water management ability. The platinum-based catalysts grown in situ on the surface of the ordered structure hydrophilic layer manifest themselves in a variety of morphologies, such as nanoparticles, nanowires, nanorods, nano-dendrites, etc. The morphologies such as platinum-based nano wires, nanorods, nano-dendrites and the like have large specific surface areas, so that more active sites can be exposed, the stability is higher than that of nano particles, and the performance and the stability of the catalysts are greatly improved.

Meanwhile, the catalysts are directly grown in situ on the ordered structure hydrophilic layer, so that the mass transfer resistance between the ordered structure hydrophilic layer and the catalytic layer is greatly reduced. The novel MEA has good mass transfer channels, lower mass transfer resistance, larger electrochemical surface area and stronger catalyst stability, consequently leading to an enhanced performance and durability of the resulting PEMFC.

The present disclosure achieves the above technical objects by the following technical schemes.

A fuel cell electrode with catalysts grown in situ on an ordered structure microporous layer according to the disclosure includes: an electrode substrate layer, a hydrophobic layer, an ordered structure hydrophilic layer and catalysts. The hydrophobic layer is prepared on the electrode substrate layer; the ordered structure hydrophilic layer is prepared on the hydrophobic layer, and catalysts are uniformly distributed on the ordered structure hydrophilic layer. The catalysts are platinum-based catalysts, and the morphology of the platinum-based catalyst comprises nanowires, nanorods and nano-dendrites.

Further, the platinum-based catalyst is selected from the group consisting of platinum, platinum copper, platinum silver, platinum iridium, platinum ruthenium and platinum rhodium.

Further, the electrode substrate layer is selected from the group consisting of carbon fiber paper, carbon fiber woven cloth, carbon black paper and carbon felt.

Further, the ordered structure hydrophilic layer is an ordered vertical rod array having a monomer diameter of 0.5-1 μm, a pitch of 1-2 μm, and a length of 7-15 μm.

An MEA according to the disclosure is prepared from the fuel cell electrode with catalysts grown in situ on an ordered structure microporous layer. The fuel cell electrode with catalyst grown in situ on the ordered structure microporous layer serves as a cathode, the Pt/C electrode serves as an anode, and the proton exchange membrane is arranged therebetween.

Further, the proton exchange membrane is a perfluorosulfonic acid membrane.

Further, the proton exchange membrane is treated by hydrogen peroxide and sulfuric acid.

A method for preparing a MEA from a fuel cell electrode grown with catalysts in situ on an ordered structure microporous layer includes the following steps:

Step 1: processing the electrode substrate layer: selecting a carbon paper or a carbon cloth as the electrode substrate layer; washing the electrode substrate layer in a boiling organic solvent to remove surface impurities; soaking the electrode substrate layer in a hydrophobic agent for a period of time; followed by drying, sintering, and performing a hydrophobic treatment;

Step 2: preparing the hydrophobic layer: uniformly dispersing a certain amount of an acid-treated carbon powder, a hydrophobic agent and a pore-forming agent in an isopropanol, and ultrasonically forming a uniformly dispersed slurry; then uniformly spraying the slurry onto one side of the carbon paper or the carbon cloth treated in the step 1; then drying and sintering the slurry to prepare the hydrophobic layer;

Step 3: preparing the ordered structure hydrophilic layer: uniformly dispersing a certain amount of an acid-treated carbon powder, a hydrophilic agent and a pore-forming agent together in an isopropanol; ultrasonically forming a uniformly dispersed slurry, and uniformly spraying the slurry onto surfaces of the hydrophobic layer prepared in the step 2; and etching the hydrophilic layer by an anodic aluminum oxide (AAO) template to form an ordered microporous channel before the hydrophilic layer becomes dry; then completely etching the AAO template with an acid, followed by washing and drying to prepare a gas diffusion layer (GDL) having an ordered porous double microporous layer;

Step 4: in-situ growing the platinum-based catalysts: fixing the GDL obtained in the step 3 at a bottom of a reaction container with the hydrophilic layer facing upwards; sequentially adding platinum or a precursor of platinum and other metals, a reducing agent and a surfactant into the container; letting the reaction container stand at room temperature to enable the platinum-based catalysts to reductively grow onto the hydrophilic layer ordered array; and after the reaction is completed, washing and drying to obtain a platinum-based catalytic layer based on an ordered array microporous layer; uniformly dripping a certain amount of a proton conductor solution on a surface of the catalytic layer; letting the surface stand at room temperature for a period of time to let the proton conductor become uniformly distributed in the catalytic layer; then drying to obtain a gas diffusion electrode (GDE) based on an ordered microporous layer; and,

Step 5: preparing the MEA: using the GDE in step 4 as a cathode, and a conventional Pt/C electrode as an anode, placing a proton exchange membrane therebetween, and hot-pressing the layers together to obtain the MEA with catalysts grown in situ on the ordered structure microporous layer.

Beneficial Effects are summarized as follows.

1. The microporous layer is optimized to have an ordered porous structure, and the platinum-based catalysts are grown in situ on it to form an electrode with catalysts grown in situ on the ordered structure microporous layer. Owing to the existence of the ordered porous structure, a water management system of the MEA is optimized to reduce the transfer resistance of mass such as water, gas, protons and electrons. The microporous layer and the catalytic layer are combined into a union, which effectively reduces the contact resistance. The in-situ growth of platinum-based catalyst on the inner wall of micropores significantly increases the electrochemical reaction area and enhances the stability of the catalysts. The MEA can effectively improve the electrochemical reaction rate, the energy conversion rate and the catalyst utilization rate, and facilitates improvement in the durability of the fuel cell.

2. The platinum-based catalyst grown in situ on the surface of the ordered structure hydrophilic layer manifests itself in a variety of morphologies, such as nanoparticles, nanowires, nanorods, nano-dendrites, etc. The morphologies such as platinum-based nanowires, nanorods, nano-dendrites and the like have large specific surface areas, so that more active sites can be exposed, the stability is higher than that of nano particles, and the performance and stability of the catalysts can be greatly improved. Meanwhile, the catalysts are directly grown in situ on the ordered structure hydrophilic layer, which can greatly reduce the mass transfer resistance between the ordered structure hydrophilic layer and the catalytic layer. This novel MEA has good mass transport channels, low mass transfer resistance, large electrochemical surface area and good catalyst stability, which favor the improvement of the fuel cell performance.

3. The microporous layer is a double-layer structure with a hydrophobic layer and a hydrophilic layer. The hydrophilic layer is formed in an ordered vertical array rod-shaped structure, which is beneficial to the three-phase transport of substances, reduces the mass transfer resistance of the fuel cell, increases the surface area of the microporous layer, and provides more catalyst deposition sites. The Pt-based catalysts are directly grown in situ on the microporous layer, and the catalysts manifest themselves in different morphologies such as nanoparticles, nanowires, nanorods, nano dendrites and the like on the microporous layer, so that the electrochemical active surface area and catalytic activity are increased, the transfer resistance between the microporous layer and the catalytic layer is reduced, and, as a result, the fuel cell performance can be effectively improved. Moreover, catalysts with special morphologies such as nano wires, nano rods, nano dendrites and the like have excellent stability, so the durability of the fuel cell can be effectively improved.

### BRIEF DESCRIPTION OF THE DRAWINGS

FIG. 1 is the schematic diagram of the structure of the fuel cell electrode with catalysts grown in situ on the ordered structure microporous layer according to the present disclosure; and

FIG. 2 is the flow diagram of the process for preparing the fuel cell electrode grown in situ on the ordered structure microporous layer according to the present disclosure.

### REFERENCE NUMERALS

1-electrode substrate layer; 2-hydrophobic layer; 3-ordered structure hydrophilic layer; 4-catalyst

### DETAILED DESCRIPTION OF THE EMBODIMENTS

Reference will now be made in detail to the embodiments of the present disclosure, examples of which are illustrated in the accompanying drawings, in which like or similar reference numerals refer to the same or similar elements or elements having the same or similar function throughout. The embodiments described below by reference to the drawings are exemplary and are intended to explain the present disclosure and are not to be construed as limiting the present disclosure.

Hereinafter, a fuel cell electrode with catalysts grown in situ on an ordered structure microporous layer according to an embodiment of the present disclosure is described in detail with reference to the accompanying drawings. The fuel cell electrode includes: a gas diffusion layer (GDL), catalysts and a proton conductor. The GDL includes an electrode substrate layer and a microporous layer. The catalysts are platinum or platinum and other metal catalysts, which are prepared by directly reducing platinum or other metal precursors on the microporous layer by a reducing agent. The microporous layer is a double-layer structure with a hydrophobic layer and an ordered vertical array hydrophilic layer.

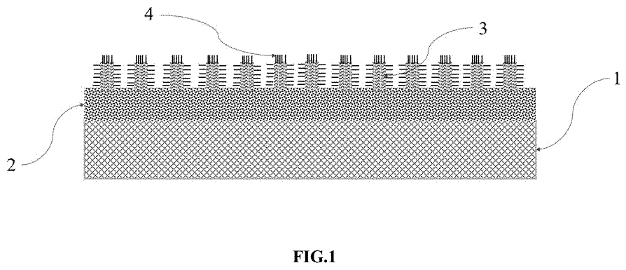

The fuel cell electrode structure with catalysts grown in situ on an ordered structure microporous layer of the present disclosure is illustrated in conjunction with FIG. 1. The electrode includes a GDL, a double microporous layer and platinum-based catalysts grown on the hydrophilic microporous layer. The novel ordered electrode increases the specific surface area of the microporous layer, thereby increasing the actual area of the electrochemical reaction. Secondly, the platinum-based nanowires, nanorods or nano-dendrites grown in situ on the microporous layer have higher specific activity and stability, which can greatly improve the performance and durability of the proton exchange membrane fuel cell (PEMFC). The method for preparing the MEA from the fuel cell electrode structure with catalysts grown in situ on an ordered structure microporous layer includes:

Step 1: processing an electrode substrate layer: selecting a carbon paper or a carbon cloth or the like as the electrode substrate layer; cutting it to an appropriate size; then washing it in a boiling organic solvent to remove surface impurities; then soaking it in a hydrophobic agent for a period of time; followed by drying, sintering, and performing a hydrophobic treatment;

Step 2: preparing the hydrophobic layer: uniformly dispersing a certain amount of an acid-treated carbon powder, a hydrophobic agent and a pore-forming agent in an isopropanol, and ultrasonically forming a uniformly dispersed slurry; then uniformly spraying the slurry onto one side of the carbon paper or the carbon cloth treated in the step 1; then drying and sintering the slurry to prepare the hydrophobic layer;

Step 3: preparing the ordered structure hydrophilic layer: uniformly dispersing a certain amount of an acid-treated carbon powder, a hydrophilic agent and a pore-forming agent together in isopropanol, ultrasonically forming a uniformly dispersed slurry, and uniformly spraying the slurry onto surfaces of the hydrophobic layer prepared in the step 2; and etching the hydrophilic layer by an AAO template to form an ordered microporous channel before the hydrophilic layer becomes dry; and then completely etching the AAO template with an acid; followed by washing and drying to prepare a GDL having an ordered porous double microporous layer;

Step 4: in-situ growing the platinum-based catalysts: fixing the GDL obtained in the step 3 at a bottom of a reaction container with the hydrophilic layer facing upwards; sequentially adding platinum or a precursor of platinum and other metals, a reducing agent and a surfactant into the container; letting the reaction container stand at room temperature to enable the platinum-based catalysts to reductively grow onto the hydrophilic layer ordered array; and after the reaction is completed, washing and drying to obtain a platinum-based catalytic layer based on an ordered array microporous layer; uniformly dripping a certain amount of a proton conductor solution on a surface of the catalytic layer; letting the surface stand at room temperature for a period of time to let the proton conductor become uniformly distributed in the catalytic layer; then drying to obtain a gas diffusion electrode (GDE) based on an ordered microporous layer; and

Step 5: preparing the MEA: using the GDE in step 4 as a cathode, and a conventional Pt/C electrode as an anode, placing a proton exchange membrane therebetween, and hot-pressing the layers together to obtain the MEA with catalysts grown in situ on the ordered structure microporous layer.

The following are illustrative embodiments of the disclosure:

### Embodiment 1

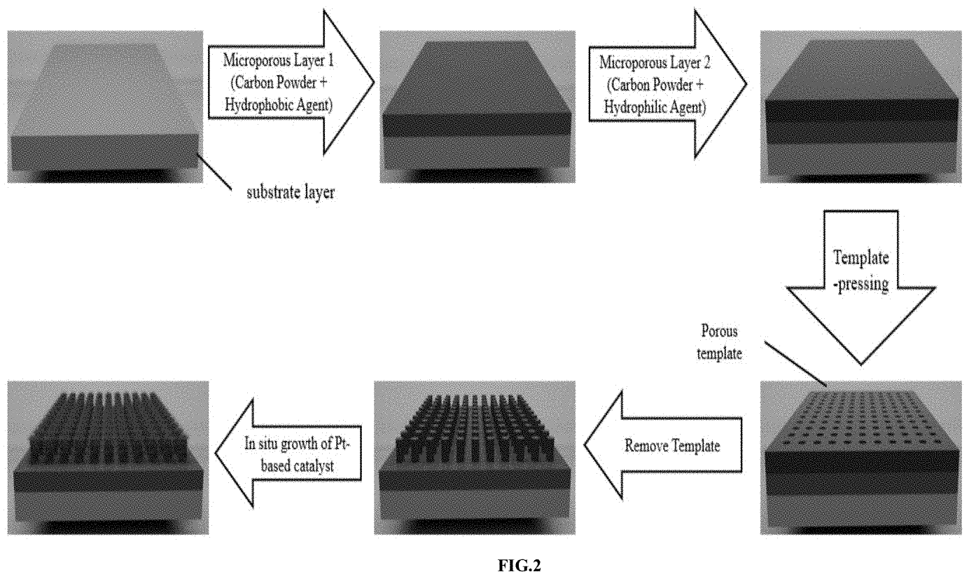

A fuel cell electrode with platinum nanowires grown in situ on an ordered structure microporous layer is prepared by referring to the flow chart and the process shown in FIG. 2, and a single cell test is performed. The main steps are as follows.

(1) Preparation of the ordered structure microporous layer: (a) dispersing acid-treated carbon powder (Vulcan XC-72R), polytetrafluoroethylene (PTFE) and NH₄Cl in an isopropanol dispersion liquid; ultrasonically homogenizing it, and spraying it uniformly onto the surface of hydrophobic treated carbon paper; drying it for 2 hours at 70° C.; sintering it in a 370° C. muffle furnace for 30 minutes; taking it out, cooling it, weighing it and calculating to obtain a hydrophobic microporous layer with a carbon powder loading of 1-1.5 mg cm⁻² and PTFE: C=15 wt. %. (b) dispersing acid-treated carbon powder (Vulcan XC-72R), Nafion and NH₄Cl in the isopropanol dispersion liquid; ultrasonically homogenizing it and spraying it uniformly onto the hydrophobic microporous layer; etching the microporous layer by an AAO template (pore diameter of 0.5 μm and pore spacing of 1 μm) before drying; after the etching, completely etching the AAO template with hydrochloric acid to form ordered micropore channels; then washing with deionized water more than 5 times; finally drying it for 2 hours at 70° C., taking it out, cooling it, weighing it and calculating to obtain a hydrophilic ordered microporous layer with a carbon powder loading of 1-1.5 mg cm⁻² and Nafion: C=15 wt. %.

(2) Preparation of in situ growth platinum nanowires and novel electrodes: fixing the GDL obtained in the step (1) at the bottom of a reaction container with the hydrophilic layer facing upwards; adding a certain amount of water into the container, then adding a certain amount of chloroplatinic acid and formic acid; letting the reaction container stand at room temperature for 72 hours; taking out the GDL after the solution is completely transparent; washing it with deionized water more than 5 times; and then drying for 12 hours at 70° C. to obtain an electrode with platinum loading of 0.3 mg cm⁻²; then uniformly dropping a proton conductor (Pt: Nafion=1:1) onto the surface of the catalytic layer; letting it stand at room temperature for more than 12 hours to let the proton conductor become uniformly distributed in the catalysts; and then drying for 2 hours at 70° C. to obtain the novel electrode with the catalysts grown in situ on the ordered structure microporous layer.

(3) Preparation of an MEA and a single cell: using the conventional electrode (with a platinum loading of 0.2 mg cm⁻²) prepared in step (2) of Comparative Example 1 (hereinafter) as an anode, and the platinum nanowire electrode prepared in step (2) as a cathode, separating the anode and the cathode with the Nafion211 membrane that was pretreated with hydrogen peroxide and sulfuric acid, and hot pressing the layers together for 5 minutes using a hot press machine to obtain the MEA.

(4) Single cell performance test: performing a discharge test after the MEA is assembled in the single cell system. The test conditions are as follows: the cell working temperature of 60° C., the relative humidity of 100%, and normal pressure; introducing hydrogen into the anode and oxygen into the cathode, with the flow rate of 100SCCM and 150SCCM respectively. The test results show that the current density can reach 1.0 A cm⁻², and the maximum power density can reach 0.746 W cm⁻² at a working voltage of 0.6 V.

### Embodiment 2

The template parameters for preparing an ordered structure microporous layer are pore diameter 1 μm, pore spacing 2 μm, and other relevant parameters in the MEA are the same as those in Embodiment 1. The cell test conditions are the same as in Embodiment 1. The test results show that the current density can reach 1.0 A cm⁻², and the maximum power density can reach 0.716 W cm⁻² at the working voltage of 0.6 V.

### Embodiment 3

A fuel cell electrode with platinum nanorods grown in situ on an ordered structure microporous layer is prepared by referring to the flow chart and the process shown in FIG. 2, and a single cell performance test is performed. The reducing agent for the in situ growth of the platinum catalyst is ascorbic acid. The obtained catalyst manifests itself in the morphology of a nanorod. Other relevant parameters for the MEA are the same as those in the Embodiment 1, and the cell test conditions are the same as those in Embodiment 1. The test results show that the current density can reach 1.0 A cm⁻², and the maximum power density can reach 0.713 W cm⁻² at the working voltage of 0.6 V.

### Embodiment 4

A fuel cell electrode with platinum/copper nanowires grown in situ on an ordered structure microporous layer is prepared by referring to the flow chart and the process shown in FIG. 2, and a single cell performance test is performed. The main steps are as follows:

Fixing the GDL obtained in the step (1) of Embodiment 1 at the bottom of a reaction container with the hydrophilic layer facing upwards; adding a certain amount of water into the container, then adding a certain amount of copper chloride aqueous solution and ascorbic acid; letting the reaction container stand at room temperature for 4 hours, then adding a small amount of hexadecyltrimethylammonium chloride (CTAC); letting the container stand at room temperature for another 6 hours to let the copper nanowires grow completely on the ordered structure microporous layer; then washing with water and drying to obtain an electrode with copper nanowires grown in situ on the ordered structure microporous layer; the copper loading amount is 0.5 mg cm⁻²; then fixing the copper nanowire electrode at the bottom of a reaction container with the copper nanowires facing upwards, adding a certain amount of water into the container, then adding a certain amount of chloroplatinic acid; letting the container stand at room temperature for more than 6 hours to let the platinum become fully reduced; then washing with water and drying to obtain a platinum loading of 0.25 mg cm⁻²; and then uniformly dropping a proton conductor (Pt: Nafion=1:1) onto the surface of the catalytic layer; letting the container stand at room temperature for more than 12 hours to ensure the proton conductor becomes uniformly distributed on the surfaces of the platinum/copper nanowires; and then drying for 2 hours at 70° C. to obtain the fuel cell electrode with the platinum/copper nanowires grown in situ on the ordered structure microporous layer; the preparation of the MEA, the assembly of the single cell and the discharge test are the same as in steps (3) and (4) of Embodiment 1. The test results show that the current density can reach 1.1 A cm⁻², and the maximum power density can reach 0.761 W cm⁻²

### Embodiment 5

A platinum/silver nanoparticle catalyst is grown in situ on an ordered structure microporous layer to prepare the platinum/silver nanoparticles as catalyst for a fuel cell cathode. The main steps are as follows:

Fixing the GDL obtained in the step (1) in Embodiment 1 at the bottom of a reaction container with the hydrophilic layer facing upward; adding a certain amount of water into the container; adding a certain amount of mixed solution of chloroplatinic acid and silver nitrate (the content ratio of platinum to silver is 1:1); adding a proper amount of formic acid; letting the container stand at room temperature for 72 hours; and taking out the GDL after the chloroplatinic acid and the silver nitrate are completely reduced; washing with deionized water more than 5 times; and then drying for 12 hours at 70° C. to obtain an electrode with platinum/silver catalysts loading of 0.5 mg cm⁻²; uniformly dropping proton conductor (Pt: Nafion=1:1) onto the surface of the catalytic layer; letting it stand for more than 12 hours at room temperature to let the proton conductor become uniformly distributed in the catalysts; and then drying for 2 hours at 70° C. to obtain a novel electrode with platinum/silver nanoparticle catalysts grown in situ on the ordered structure microporous layer; the preparation of the MEA, the assembly of the single cell and the discharge test are the same as in step (3) and step (4) of Embodiment 1. The test results show that the current density can reach 1.3 A cm⁻², and the maximum power density can reach 0.815 W cm⁻² at the working voltage of 0.6 V.

### Embodiment 6

A platinum/nickel nanocluster catalyst is grown in situ on an ordered structure microporous layer to prepare the platinum/nickel catalyst as catalyst for a fuel cell cathode. The main steps are as follows:

Fixing the GDL obtained in the step (1) in Embodiment 1 at the bottom of a reaction container with the hydrophilic layer facing upward; adding a certain amount of water into the container; adding a certain amount of mixed solution of chloroplatinic acid and nickel chloride (the content ratio of platinum to nickel is 1:1); adding a proper amount of formic acid; letting the container stand at room temperature for 72 hours; and taking out the GDL after the chloroplatinic acid and the nickel chloride are completely reduced; washing with deionized water more than 5 times; and then drying for 12 hours at 70° C. to obtain an electrode with platinum/nickel catalysts loading of 0.5 mg cm⁻²; uniformly dropping proton conductor (Pt:Nafion=1:1) onto the surface of the catalytic layer; letting it stand for more than 12 hours at room temperature to let the proton conductor become uniformly distributed in the catalysts; and drying for 2 hours at 70° C. to obtain a novel electrode with platinum/nickel nanocluster catalysts grown in situ on the ordered structure microporous layer; the preparation of the MEA, the assembly of the single cell and the discharge test are the same as in step (3) and step (4) of Embodiment 1. The test results show that the current density can reach 1.0 A cm⁻², and the maximum power density can reach 0.738 W cm⁻² at the working voltage of 0.6 V.

### Embodiment 7

A platinum nano dendritic crystal catalyst is grown in situ on an ordered structure microporous layer to prepare the platinum nano-dendrites catalyst as a fuel cell cathode catalyst. The main steps are as follows:

Fixing the GDL obtained in the step (1) in Embodiment 1 at the bottom of a reaction container with the hydrophilic layer facing upwards; adding a certain amount of water into the container; adding a certain amount of mixed solution of chloroplatinic acid and ferric chloride (the content ratio of platinum to nickel is 1:1); adding a proper amount of formic acid; letting the container stand at room temperature for 72 hours; and continuously adding excess hydrochloric acid after the chloroplatinic acid and the ferric chloride are completely reduced to dissolve the iron completely, and then taking out the GDL; washing with deionized water more than 5 times; then drying at 70° C. for 12 hours to obtain an electrode with platinum nano-dendritic catalysts loading of 0.3 mg cm⁻²; uniformly dropping proton conductor (Pt:Nafion=1:1) onto the surface of the catalytic layer; letting it stand at room temperature for more than 12 hours to ensure the proton conductor becomes uniformly distributed on the surface of the platinum nano-dendritic catalysts; and then drying at 70° C. for 2 hours to obtain the novel electrode with platinum nano-dendrites catalysts grown in situ on the ordered structure microporous layer; the preparation of the MEA, the assembly of the single cell and the discharge test are the same as in step (3) and step (4) of Embodiment 1. The test results show that the current density can reach 1.3 A cm⁻², and the maximum power density can reach 0.839Wcm⁻² at the working voltage of 0.6V.

The Following are Comparative Examples:

### COMPARATIVE EXAMPLE 1

An acidic polyelectrolyte membrane fuel cell with a conventional catalytic structure is prepared and the single cell performance test is performed. Both the anode and the cathode of this comparative fuel cell are conventional electrodes, and the main steps are as follows.

(1) Treatment of the carbon paper: the carbon paper (Toray-090) is selected as the GDL. First, the carbon paper is subjected to decontamination treatment by soaking it in acetone, heating it and boiling it for 15-20 minutes to remove impurities on the surface and in the pores of the carbon paper; then drying it at 70° C. Then, it is soaked in the dispersion of the PTFE for hydrophobic treatment, taken out after a period of time, dried at 70° C. for 2 hours, and then put into a muffle furnace at 370° C. for 30 minutes to make the content of PTFE reach 15-20 wt. %.

(2) Preparation of conventional electrodes: (a) dispersing the carbon powder (Vulcan XC-72R) and the PTFE in isopropyl alcohol dispersion; ultrasonically homogenizing it and spraying it uniformly onto a carbon paper containing a hydrophobic layer; drying it at 70° C. for 2 hours, then sintering it in a muffle furnace for 30 minutes at 370° C.; taking it out, cooling it and weighing it to obtain a hydrophobic layer with carbon powder loading of 2-3 mg cm⁻² and PTFE:C=15 wt. %. (b) weighing a proper amount of 40 wt. % Pt/C and Nafion and dispersing them in isopropanol dispersion liquid; ultrasonically homogenizing and spraying the dispersion uniformly on the hydrophobic layer obtained in (a); drying it for 2 hours at 70° C., taking it out, cooling it, weighing it and calculating to obtain a conventional electrode with platinum catalyst loading of 0.2 mg cm⁻² and 0.3 mg cm⁻² respectively.

(3) Preparation of a conventional MEA and the assembly of a single cell: using two conventional electrodes prepared in the step (2) as the cathode (with a Pt loading of 0.3 mg cm⁻²) and the anode (with a Pt loading of 0.2 mg cm⁻²) of the cell; separating the anode and the cathode by the Nafion211 membrane that was pretreated with hydrogen peroxide and sulfuric acid; and then hot pressing the layers for 5 minutes by the hot press machine to obtain the conventional MEA.

(4) Single cell performance test: performing a discharge test after the membrane and the electrodes are assembled in the single cell system. The test conditions are: the cell working temperature of 60° C., the relative humidity of 100%, normal pressure; introducing hydrogen into the anode and oxygen into the cathode, with the flow rate of 100SCCM and 150SCCM respectively. The test results show that the current density can reach 0.8 A cm⁻², and the maximum power density can reach 0.542 W cm⁻² at the working voltage of 0.6 V. Both of these numbers are lower than the performance test results for Embodiments 1-7 above.

### COMPARATIVE EXAMPLE 2

Fuel cell electrodes with Pt nanowires grown in situ on conventional GDLs are prepared and the single cell test is performed. The MEA of this example is different from the embodiment 1 in that the microporous layer is not etched with a porous template, but Pt nanowires are directly grown in situ on the hydrophilic layer with Pt loading of 0.3 mg cm⁻². The fuel cell assembly and discharge performance tests are the same as in embodiment 1. The test results show that the current density can reach 1.0 A cm⁻², and the maximum power density can reach 0.684 W cm⁻² at the working voltage of 0.6 V.

It can be seen from the Comparative Examples that the fuel cell electrodes with catalysts grown in situ on the ordered structure microporous layer disclosed by the disclosure has better performance, and the preparation method of the novel electrode is conducive to electrochemical reaction efficiency, electron/ion conduction and mass transfer.

In the description of this specification, the description referring to the terms “one embodiment”, “some embodiments”, “examples”, “specific examples”, or “some examples” means that the specific feature, structure, material, or features described in connection with the embodiment or example are included in at least one embodiment or example of the present disclosure. In this specification, the illustrative expressions of the above terms do not necessarily refer to the same embodiment or example. Moreover, the particular features, structures, materials, or features described may be combined in a suitable manner in any one or more embodiments or examples.

Although the embodiments of the present disclosure have been illustrated and described above, it is to be understood that the above embodiments are exemplary and are not to be construed as limiting the present disclosure. Those of ordinary skill in the art may make changes, modifications, substitutions and alterations to the above embodiments within the scope of the present disclosure without departing from the principles and spirit of the present disclosure.

What is claimed is:

1. A fuel cell electrode with catalysts grown in situ on an ordered structure microporous layer, comprising:
an electrode substrate layer, a hydrophobic layer, an ordered structure hydrophilic layer and catalysts;
wherein the hydrophobic layer is prepared on the electrode substrate layer; the ordered structure hydrophilic layer is prepared on the hydrophobic layer; and the catalysts are uniformly distributed on the ordered structure hydrophilic layer; and
wherein the catalysts are platinum-based catalysts, and a morphology of the platinum-based catalyst is one of nanowires, nanorods and nano-dendrites.

2. The fuel cell electrode of claim 1 with catalysts grown in situ on an ordered structure microporous layer, wherein the platinum-based catalyst is selected from the group consisting of platinum, platinum copper, platinum silver, platinum iridium, platinum ruthenium and platinum rhodium.

3. The fuel cell electrode of claim 1 with catalysts grown in situ on an ordered structure microporous layer, wherein the electrode substrate layer is selected from the group consisting of a carbon fiber paper, a carbon fiber woven cloth, a carbon black paper and a carbon felt.

4. The fuel cell electrode of claim 1 with catalysts grown in situ on an ordered structure microporous layer, wherein the ordered structure hydrophilic layer is an ordered vertical rod array having a monomer diameter of 0.5-1 μm, a pitch of 1-2 μm, and a length of 7-15 μm.

5. A membrane electrode assembly (MEA) prepared from the fuel cell electrode of claim 1 with catalysts grown in situ on an ordered structure microporous layer, wherein the fuel cell electrode with the catalysts grown in situ on an ordered structure microporous layer serves as a cathode, a Pt/C electrode serves as an anode, and a proton exchange membrane is provided therebetween.

6. The MEA of claim 5 prepared from the fuel cell electrode with catalysts grown in situ on an ordered structure microporous layer, wherein the proton exchange membrane is a perfluorosulfonic acid membrane.

7. The MEA of claim 5 prepared from the fuel cell electrode with catalysts grown in situ on an ordered structure microporous layer, wherein the proton exchange membrane is treated with hydrogen peroxide and sulfuric acid.

8. The MEA of claim 5 prepared from the fuel cell electrode with catalysts grown in situ on an ordered structure microporous layer, wherein the platinum-based catalyst is selected from the group consisting of platinum, platinum copper, platinum silver, platinum iridium, platinum ruthenium and platinum rhodium.

9. The MEA of claim 5 prepared from the fuel cell electrode with catalysts grown in situ on an ordered structure microporous layer 5, wherein the electrode substrate layer is selected from the group consisting of a carbon fiber paper, a carbon fiber woven cloth, a carbon black paper and a carbon felt.

10. The MEA of claim 5 prepared from the fuel cell electrode with catalysts grown in situ on an ordered structure microporous layer, wherein the ordered structure hydrophilic layer is an ordered vertical rod array having a monomer diameter of 0.5-1 μm, a pitch of 1-2 μm, and a length of 7-15 μm.

11. A method for preparing a membrane electrode assembly (MEA) from a fuel cell electrode with catalysts grown in situ on an ordered structure microporous layer comprising:
step 1: an electrode substrate layer is prepared as follows: selecting a carbon paper or a carbon cloth as the electrode substrate layer; washing the electrode substrate layer in a boiling organic solvent to remove surface impurities; soaking the electrode substrate layer in a hydrophobic agent for a period of time; followed by drying, sintering, and performing a hydrophobic treatment;
step 2: a hydrophobic layer is prepared as follows: uniformly dispersing a certain amount of acid-treated carbon powder, a hydrophobic agent and a pore-forming agent in isopropanol, and ultrasonically forming a uniformly dispersed slurry; then uniformly spraying the slurry onto one side of the carbon paper or the carbon cloth prepared in step 1 above, followed by drying and sintering the slurry to prepare the hydrophobic layer;
step 3: an ordered structure hydrophilic layer is prepared as follows: uniformly dispersing a certain amount of acid-treated carbon powder, a hydrophilic agent and a pore-forming agent together in isopropanol, and ultrasonically forming a uniformly dispersed slurry; uniformly spraying the slurry onto surfaces of the hydrophobic layer prepared in step 2 above, and etching the hydrophilic layer by an anodic aluminum oxide (AAO) template to form ordered microporous channels before the hydrophilic layer becomes dry; and then completely etching the AAO template with an acid; followed by washing and drying to prepare a gas diffusion layer (GDL) having an ordered porous double microporous layer;
step 4: platinum-based catalysts are grown in-situ as follows: fixing the GDL obtained in step 3 above at a bottom of a reaction container with the hydrophilic layer facing upwards; sequentially adding platinum or a precursor of platinum and other metals, a reducing agent and a surfactant into the container; letting the reaction container stand at room temperature to enable the platinum-based catalysts to be reduced and grown onto the hydrophilic layer ordered array; and, after the reaction is completed, washing and drying the layer to obtain a platinum-based catalytic layer based on an ordered array microporous layer; uniformly dripping a certain amount of a proton conductor solution on a surface of the catalytic layer; letting it stand at room temperature for a period of time to let the proton conductor become uniformly distributed in the catalytic layer; and then drying it to obtain a gas diffusion electrode (GDE) based on the ordered microporous layer; and
step 5: the MEA is prepared as follows: using the GDE prepared in step 4 above as a cathode, and the conventional Pt/C electrode as an anode, placing a proton exchange membrane therebetween, and hot-pressing the layers together to obtain the MEA with catalysts grown in situ on the ordered structure microporous layer.

12. The method of claim 11 for preparing the MEA prepared from the fuel cell electrode with catalysts grown in situ on an ordered structure microporous layer, wherein the proton exchange membrane is a perfluorosulfonic acid membrane.

13. The method of claim 11 for preparing the MEA prepared from the fuel cell electrode with catalysts grown in situ on an ordered structure microporous layer, wherein the proton exchange membrane is treated with hydrogen peroxide and sulfuric acid.

14. The method of claim 11 for preparing the MEA prepared from the fuel cell electrode with catalysts grown in situ on an ordered structure microporous layer, wherein the platinum-based catalyst is selected from the group consisting of platinum, platinum copper, platinum silver, platinum iridium, platinum ruthenium and platinum rhodium.

15. The method of claim 11 for preparing the MEA prepared from the fuel cell electrode with catalysts grown in situ on an ordered structure microporous layer, wherein the electrode substrate layer is selected from the group consisting of a carbon fiber paper, a carbon fiber woven cloth, a carbon black paper and a carbon felt.

16. The method of claim 11 for preparing the MEA prepared from the fuel cell electrode with catalysts grown in situ on an ordered structure microporous layer, wherein the ordered structure hydrophilic layer is an ordered vertical rod array having a monomer diameter of 0.5-1 μm, a pitch of 1-2 μm, and a length of 7-15 μm.
